(19) United States
(12) Patent Application Publication
(10) Pub. No.: US 2024/0198500 A1
(43) Pub. Date: Jun. 20, 2024

(54) Hand-Held Power Tool

(71) Applicant: Robert Bosch GmbH, Stuttgart (DE)

(72) Inventors: Bernhard Hegemann, Filderstadt (DE); Juergen Hesse, Waldenbuch (DE)

(21) Appl. No.: 18/543,087

(22) Filed: Dec. 18, 2023

(30) Foreign Application Priority Data
Dec. 19, 2022 (DE) 10 2022 213 862.7

(51) Int. Cl. B25B 23/06

(52) U.S. Cl. CPC B25B 23/06; B25B 21/00

(57) ABSTRACT

A hand-held machine tool, in particular a screwdriver, having a housing, having an insert tool magazine which has a plurality of insert tool chambers for holding one insert tool each and is arranged rotatably in the housing, having a tool holder for rotatably driving the insert tools, wherein the tool holder is arranged rotatably in a tool holder opening of the housing, with a feed element which is designed to displace one of the insert tools from a parking position out of one of the insert tool chambers into a working position in the tool holder, with an actuating element which is designed to actuate the feed element, and with a supporting element which is designed to support the feed element at least in the working position in the tool holder. The support element is arranged at least partially between the insert tool magazine and the actuating element.

This application claims priority under 35 U.S.C. § 119 to patent application no. 10 2022 213 862.7, filed on Dec. 19, 2022 in Germany, the disclosure of which is incorporated herein by reference in its entirety.

The present disclosure relates to a hand-held power tool.

### BACKGROUND

A motor-driven machine tool with a drive unit and a tool change magazine is known from EP 2 101 960 B1.

### SUMMARY

The present disclosure is based on a hand-held machine tool, in particular a screwdriver, with a housing, with an insert tool magazine which has a plurality of insert tool chambers for holding one insert tool each and is rotatably arranged in the housing, with a tool holder for rotatably driving at least one of the insert tools, wherein the tool holder is rotatably arranged in a tool holder opening of the housing, with a feed element which is designed to displace one of the insert tools from a parking position out of one of the insert tool chambers into a working position in the tool holder, with an actuating element which is designed to actuate the feed element, and with a supporting element which is designed to support the feed element at least in the working position in the tool holder. It is proposed that the support element be arranged at least partially between the insert tool magazine and the actuating element.

The disclosure provides a hand tool that increases user comfort by, on the one hand, enabling a compact hand tool and, on the other hand, designing the hand tool in such a way that longer screwdriver bits can be held in the insert tool magazine. With the help of the longer screwdriver bits, the user can also reach hard-to-access work areas more easily.

The hand-held power tool can be designed as an electrically operated hand-held power tool. The electrically operated hand-held power tool can be designed as a mains-operated or as a cordless hand-held power tool. For example, the hand tool can be designed as a screwdriver or a drill driver.

The housing of the hand-held machine tool is designed to at least partially hold the tool holder, a drive motor, a gear unit and the insert tool magazine. The housing can be designed as a shell housing with two half shells. The housing can have two housing halves. The housing can have at least one motor holder, which is designed to at least partially hold the drive motor and to arrange the drive motor essentially inside the housing.

The drive motor can be designed as an electric motor. The drive motor can have a motor housing, wherein the motor holder of the housing can at least partially hold the motor housing. The drive motor is designed such that it can be actuated via a manual switch. When the manual switch is actuated by a user, the drive motor is switched on and the hand-held power tool is put into operation. If the manual switch is not further actuated by the user, the drive motor is switched off. The drive motor can preferably be electronically controlled and/or regulated in such a way that a reversing mode and a specification for a desired rotational speed can be implemented. In reversing mode, the drive motor can be switched between a clockwise direction of rotation and a counterclockwise direction of rotation. To switch the drive motor in reversing mode, the hand-held power tool can comprise a rotation direction switching element, in particular a rotation direction changeover switch.

The drive motor can drive at least the gear unit by means of a motor shaft. The motor shaft can have at least one motor pinion, which can be operatively connected to the gear unit. The motor pinion can be arranged essentially inside the insert tool magazine. In addition, the drive motor can drive the tool holder by means of the motor shaft via the gear unit. The hand-held power tool can have a tool axis. A rotational axis of the motor shaft can form the tool axis. The hand-held machine tool can have a further tool axis, wherein a rotation axis of the tool holder forms the further tool axis. In particular, “axial” is to be understood as essentially parallel to the tool axis and/or to the further tool axis. Whereas “radial” should be understood as essentially perpendicular to the tool axis and/or the further tool axis.

The gear unit is arranged at least in sections within the insert tool magazine. The gear unit has a gear output shaft that drives the tool holder via an intermediate gear. The gear output shaft can protrude at least in sections from the insert tool magazine. The motor shaft and the gear output shaft can be arranged coaxially to each other. The gear unit can have a gear housing. The gear unit can, for example, be designed as a planetary gear, in particular a multi-stage planetary gear.

The housing has the tool holder opening. The tool holder is arranged rotatably in the tool holder opening so that the intermediate gear can drive the tool holder rotatably. The tool holder opening can be circular, elliptical, oval or polygonal, for example. The tool holder protrudes at least partially from the tool holder opening in the housing. The tool holder can be driven by the gear unit via the intermediate gear. The tool holder can be designed as an internal tool holder, such as a bit holder. It is also conceivable that the tool holder be designed as a drill chuck. The tool holder can hold insert tools, such as screw bits, so that the user can produce screw connections from a fastening element to a fastening carrier.

The insert tool magazine is designed to store a plurality of the selectable insert tools. The insert tool magazine can hold screwdriver bits up to an axial length of 50 mm. The insert tools can have a circumferential groove. The insert tool magazine can be designed as a drum magazine that has a plurality of insert tool chambers. The insert tool magazine can be rotated in relation to the housing. The insert tool magazine is arranged at least partially inside the housing. The housing can at least partially enclose the insert tool magazine. The insert tool chambers are designed in such a way that one of the insert tools can be held in one of the insert tool chambers. In each case, one of the insert tool chambers at least partially encloses the respective insert tool at least in the circumferential direction of the respective insert tool. The insert tool chambers can each be designed in the form of a hollow cylinder. The insert tool magazine is arranged around the gear housing in a circumferential direction.

The hand-held machine tool has the feed element. The feed element can be arranged at least partially within the housing, wherein the housing can at least partially enclose the feed element. For example, the feed element can be designed in the form of a slide. The feed element can have at least one connecting element for at least one of the insert tools, which is designed to establish a connection with at least one of the insert tools. The connecting element can, for example, be designed as a magnet that can be connected to at least one of the insert set tools. The feed element is designed to move at least one of the insert tools from the park position out of one of the insert tool chambers into the working position in the tool holder. In the park position, the insert tools are each arranged in one of the insert tool chambers of the insert tool magazine. The insert tool magazine can be rotated in the park position. In the park position, the feed element can be arranged radially between the actuating element and the drive motor. The feed element can be moved axially from the parked position along one of the tool axes in the direction of the tool holder. In the working position, at least one of the insert tools is arranged in the tool holder. At least one of the insert tools was moved axially out of one of the insert tool chambers in the direction of the tool holder and arranged in the tool holder. Once the insert tool is positioned in the tool holder by means of the feed element, the user can use the insert tool to tighten or loosen a fastening element. In the working position, the feed element can be arranged at least partially radially to one of the tool axes between a gear neck of the gear unit and the actuating element. The feed element is designed in such a way that the feed element engages at least partially around the support element.

The hand-held machine tool has the actuating element, which is designed to actuate the feed element. The actuating element is coupled to the feed element so that actuating the actuating element actuates the feed element. The actuating element can be operated by the user from outside the housing. When the user actuates the actuating element, both the actuating element and the feed element can be moved, in particular displaced, from the park position to the working position and vice versa. The housing can be arranged at least in sections and at least partially, in particular radially to the tool axis, between the actuating element and the feed element. The actuating element can be designed as an actuating slide, for example.

The hand-held machine tool has the support element. The support element is designed to support the feed element in the tool holder, at least in the working position. As an example, the support element is designed as a type of support lever. When the feed element is in the working position, the support element moves behind the feed element, in particular axially, and supports it axially so that the insert tool is blocked in the tool holder, so that the insert tool can still be used in the event of axial forces on the insert tool and undesired displacement of the insert tool and/or the feed element is prevented. In the park position, the support element releases the feed element so that the feed element can be moved. The feed element can then be moved from the working position to the park position.

The support element is arranged at least partially, in particular radially to the tool axis, between the insert tool magazine and the actuating element. The support element can be arranged along the axis of rotation of the tool holder, i.e. along the further tool axis. The support element can be arranged at least in sections, in particular radially, between the insert tool magazine and the actuating element. In addition, the support element can be arranged at least in sections, in particular radially, between the gear unit and the actuating element. The support element can be pivoted tangentially to the circumferential direction of the tool axis and/or the other tool axis. The support element can also be designed to swivel tangentially to the insert tool magazine.

The hand-held machine tool can have a control unit at least for controlling the drive motor. The control unit can be arranged in the housing. The hand-held power tool further comprises a power supply, wherein the power supply is provided for cordless operation by means of rechargeable batteries, in particular hand-held power tool rechargeable battery packs, and/or for mains operation. In a preferred embodiment, the power supply is designed for cordless operation. In the context of the present disclosure, a “hand-held power tool rechargeable battery pack” is intended to be understood as a combination of at least one rechargeable battery cell and a rechargeable battery pack housing. The hand-held power tool rechargeable battery pack is advantageously designed for supplying power to commonly available cordless hand-held power tools. The at least one rechargeable battery cell can, for instance, be designed as a Li-ion rechargeable battery cell having a nominal voltage of 3.6 V. The hand-held power tool rechargeable battery pack can comprise up to ten rechargeable battery cells, for example, wherein a different number of rechargeable battery cells also is conceivable. Both an embodiment as a cordless hand-held power tool and operation as a mains-operated hand-held power tool are sufficiently well-known to those skilled in the art, so the specifics of the power supply will not be discussed here.

In one embodiment of the hand-held machine tool, the insert tool magazine is arranged at least partially, in particular radially, between the gear unit and the support element. The insert tool magazine can be arranged radially to the drive motor and/or the gear unit essentially inside the housing. The insert tool magazine can be arranged at least in sections, in particular radially, between the gear unit and the support element. The support element can at least partially cover the insert tool magazine and the gear unit.

In one embodiment of the hand tool machine, the insert tool chambers each have at least one, in particular axial, groove through which the feed element can be guided, in particular axially, from the parking position into the working position. The grooves of the insert tool chambers can be formed axially to the tool axis, the further tool axis, the gear unit and/or the drive motor on the insert tool magazine. Each of the insert tool chambers has one of the grooves. The grooves of the insert tool chambers can be formed on the insert tool magazine in the circumferential direction. An insert tool magazine housing forms the respective groove. The grooves of the insert tool chambers can be formed in the radial direction between the gear unit and the axial groove. The grooves of the insert tool chambers can have a comparable, in particular essentially the same, axial length as the insert tool magazine. The groove of the insert tool chambers is designed in such a way that the feed element can be guided through the respective insert tool chamber to enable the feed element to be moved from the park position to the working position and vice versa. The feed element and/or the respective groove of the insert tool chambers can be designed in such a way that the feed element can at least partially plunge into the respective groove and the respective insert tool chamber during movement from the park position to the working position. If the feed element is moved further in the direction of the working position, the feed element can be moved over the respective groove and the respective insert tool chamber until the feed element is in the park position.

In one embodiment of the hand tool machine, the feed element has at least one blocking rib which, in the working position, engages in at least one of the grooves, in particular axial grooves, of the insert tool chambers. The blocking rib can be formed on the feed element in the direction of the drive motor. The blocking rib can be connected to the feed element in a form-fit, force-fit and/or material-fit manner. It is also possible for the feed element to form the blocking rib so that they are in one piece. The blocking rib can be arranged opposite the connecting element of the feed element for the insert tool. The blocking rib can engage in the respective groove in such a way that in the working position the insert tool magazine, in particular the respective insert tool chamber, is blocked against rotation of the insert tool magazine. This ensures that once the feed element is in the working position, the insert tool magazine cannot be rotated to select a different insert tool.

In one embodiment of the hand-held power tool, the actuating element has at least one adjusting element which is designed to adjust the support element during a movement from the working position. The adjusting element can, for example, be hook-like, pin-like, projection-like or bar-like. The adjusting element can be connected to the actuating element in a form-fit, force-fit and/or material-fit manner. It is also possible for the adjusting element and the actuating element to be in one piece. When the actuating element is moved from the working position to the parking position, in particular when it is displaced, the adjusting element first comes into contact with the support element. If the actuating element is moved further in the direction of the parking position, the adjusting element moves, in particular presses, the support element in the direction of the housing. The support element is pivoted transversely to the tool axis and/or the other tool axis. It is possible for the adjusting element to swivel the support element radially in the direction away from the other tool axis. This causes the support element to release the feed element. The feed element can then be moved, in particular displaced, in the direction of the parking position. The support element has a contact surface against which the adjusting element can rest when the feed element is moved from the working position to the park position. The contact surface can, for example, be ramp-like, projection-like or web-like.

In one embodiment of the hand-held power tool, the actuating element is coupled to the feed element in such a way that the actuating element is at least partially movable relative to the feed element. The actuating element and the feed element can be movably coupled together. When the actuating element is displaced from the working position towards the parking position, the actuating element can move at least partially transversely to the further tool axis in order to adjust the support element. The actuating element has a connecting element for the feed element. The feed element has a holder for the connecting element of the actuating element. The holder for the connecting element of the feed element holds the connecting element in such a way that the actuating element can be displaced transversely to the further tool axis. The holder for the connecting element can be C-shaped, U-shaped or L-shaped, for example. The connecting element of the actuating element can, for example, be step-like, web-like, edge-like or projection-like.

In one embodiment of the hand-held machine tool, the feed element has at least one contact web which is designed in such a way that the support element blocks the contact web in the working position. The contact web can be formed radially of the tool axis and/or the further tool axis on the feed element. It is conceivable that the feed element and the contact web be connected to each other in a form-fit, force-fit and/or material-fit manner, wherein it is also possible that they are in one piece. The contact web can be arranged, in particular radially, at least in sections between the holder of the feed element for the actuating element and the connecting element of the feed element for the insert tool. In the working position, the support element is located behind the contact web, in particular axially, and thus blocks the contact web against axial forces on the insert tool in the working position. The axial forces are transferred into the housing by the insert tool in the working position. The holder of the feed element for the actuating element can at least partially hold the actuating element with a positive fit. The holder of the feed element couples the actuating element to the feed element in a movable manner so that the actuating element can be displaced relative to the feed element. The feed element has the blocking rib on one side and the connecting element for the insert tool, in particular the magnet, on the other side in order to couple with the respective insert tool.

In one embodiment of the hand tool machine, the contact web is designed in such a way that the contact web can be guided through one of the grooves of the insert tool chambers from the park position into the working position. The contact web is designed in such a way that the contact web can be guided at least in sections through the respective groove when the feed element is moved from the park position to the working position and vice versa. The contact web prevents the insert tool magazine from being rotated when moving from the park position to the working position. The contact web is also designed to align the insert tool magazine with the respective groove of the insert tool chamber relative to the tool holder.

In one embodiment of the hand tool, the contact web is designed in such a way that the contact web acts on the support element during a movement from the park position to the working position. When the feed element is moved from the park position to the working position, the contact web acts on the support element radially in the direction away from the other tool axis.

The support element can have at least one spring element. The spring element can be arranged between the support element and the housing. The spring element is designed to act on the support element radially in the direction of the other tool axis. As soon as the feed element has passed over the support element when moving from the park position to the working position, the spring element presses the support element behind the feed element to block it. The spring element can be designed as a coil spring or a leaf spring, for example. The housing can have a holder for the spring element. The holder for the spring element is designed to hold the spring element and to position it relative to the support element. The holder for the spring element can, for example, be pin-like, bolt-like, web-like or projection-like. The support element can have a holder for the spring element. The holder for the spring element of the support element can, for example, be shell-like, cup-like, pin-like or bolt-like. The spring element can be arranged between the holder of the housing for the spring element and the holder of the support element for the spring element.

In one embodiment of the hand tool, the feed element has at least one alignment element which is designed to align the feed element relative to the housing from the park position to the working position. The alignment element and the holder of the feed element for the actuating element can be in one piece. The alignment element can at least partially rest against the housing. The alignment element can be designed as a plate or a disk, for example. The housing can be arranged at least partially and at least in sections radially to the tool axis and/or to the further tool axis between the feed element and the actuating element. The alignment element makes it possible to prevent the feed element from tilting during the movement, in particular the displacement, from the park position to the working position and vice versa. The contact web can be arranged, in particular radially, between the holder of the feed element for the actuating element or the alignment element and the connecting element of the feed element for the insertion tool.

The housing has a holder for the connecting element of the feed element for the insert tool. The holder for the connecting element of the feed element for the insert tool can, for example, be shell-like, cup-like or shaft-like. The holder for the connecting element of the feed element for the insertion tool is designed in such a way that the holder at least partially holds and at least supports the connecting element in the parked position. The holder for the connecting element of the feed element for the insert tool can be connected to the housing in a form-fit, force-fit and/or material-fit manner. It is possible for the housing to form the holder for the connecting element of the feed element for the insert tool so that they are in one piece. The holder for the connecting element of the feed element for the insert tool can be arranged radially to the tool axis at least partially between the drive motor and the actuating element and/or the feed element in the parking position inside the housing. It is possible for each of the housing halves to form one of the holders for the connecting element of the feed element for the insert tool.

The feed element has at least one locking element. The housing has at least one locking holder. The locking holder is designed in such a way that the locking holder locks the locking element in the park position. The locking element can be designed like a ramp, for example. The locking holder can, for example, be designed as a bar formed by the housing. When the feed element is moved from the working position to the park position, the locking element can engage behind the locking holder. This allows the locking element to lock the feed element in the park position in such a way that a resistance must first be overcome to move the feed element before the feed element can be moved further towards the working position. The locking element can be arranged axially between the blocking rib and the connecting element of the feed element for the insert tool. It is possible for the feed element to have two locking elements. It is also possible for the housing to have two locking holders.

The housing can have a holder for a free end of the support element. The free end of the support element can be arranged essentially inside the housing and opposite the tool holder. The free end of the support element can be held by the holder of the housing for the free end of the support element in such a way that the support element is designed to pivot essentially within the housing.

### BRIEF DESCRIPTION OF THE DRAWINGS

The disclosure is explained in more detail in the following with reference to a preferred embodiment. In the following, the drawings show:

FIG. 1 a side view of a hand tool machine according to the disclosure;

FIG. 2 a section of a perspective longitudinal section of the hand machine tool in a parking position;

FIG. 3a a section of a blocked feed element of the hand tool machine in a working position;

FIG. 3b the section of a released feed element of the hand tool machine;

FIG. 4a a perspective view of one half of a housing of the hand tool machine;

FIG. 4b a perspective view of a support element of the hand tool machine;

FIG. 4c a perspective view of a feed element of the hand tool machine;

FIG. 4d a perspective view of an actuating element of the hand tool;

### DETAILED DESCRIPTION

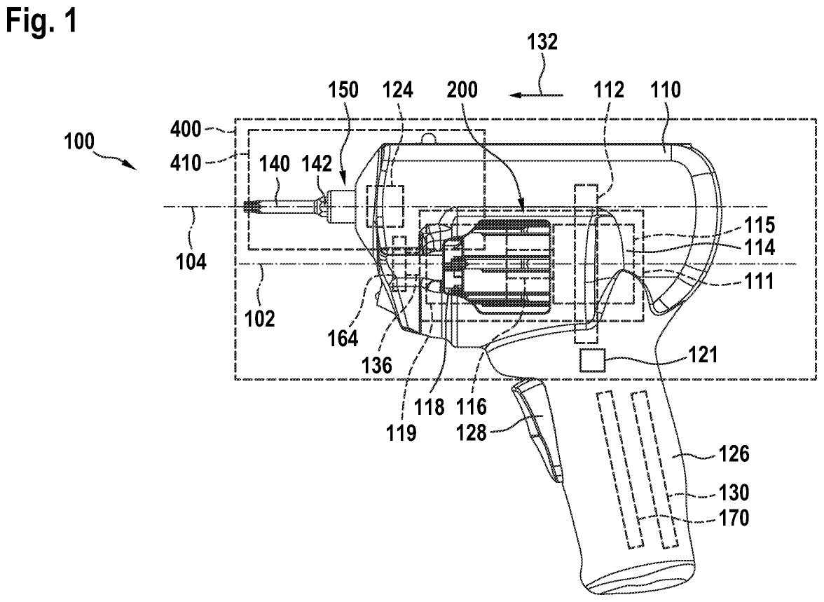

FIG. 1 shows a hand-held machine tool 100 according to the disclosure, wherein it is designed here as an exemplary cordless screwdriver. The hand tool 100 comprises an output shaft 124 and a tool holder 150. The hand-held power tool 100 comprises a housing 110 with a handle 126. To provide a mains-independent power supply, the hand-held power tool 100 can be mechanically and electrically connected to a power supply for cordless operation, so that the hand-held power tool 100 is designed as a cordless hand-held power tool 100. A permanently installed 130 rechargeable battery serves as the power supply. However, the present disclosure is not limited to cordless hand-held power tools, but can also be applied to mains-dependent, i.e., mains-powered, hand-held power tools.

The housing 110 comprises a drive unit 111, wherein the drive unit 111 is arranged at least partially in the housing 110. The drive unit 111 comprises an electric drive motor 114, which is supplied with power by the rechargeable battery 130, and a gear unit 118. The drive motor 114 comprises a motor housing 115. The gear unit 118 is designed as a planetary gear 166. The drive motor 114 is designed such that it can be actuated, for example via a manual switch 128, so that the drive motor 114 can be switched on and off. The drive motor 114 can advantageously be electronically controlled and/or regulated, so that a reversing mode and a desired rotational speed can be implemented. For the reversing mode, the hand-held power tool 100 comprises a rotation direction switching element 121 designed as a rotation direction changeover switch. The rotation direction switching element 121 is designed to switch the drive motor 114 between a clockwise direction of rotation and a counterclockwise direction of rotation. The design and mode of operation of a suitable drive motor are well known to those skilled in the art, which is why they will not be discussed in detail here.

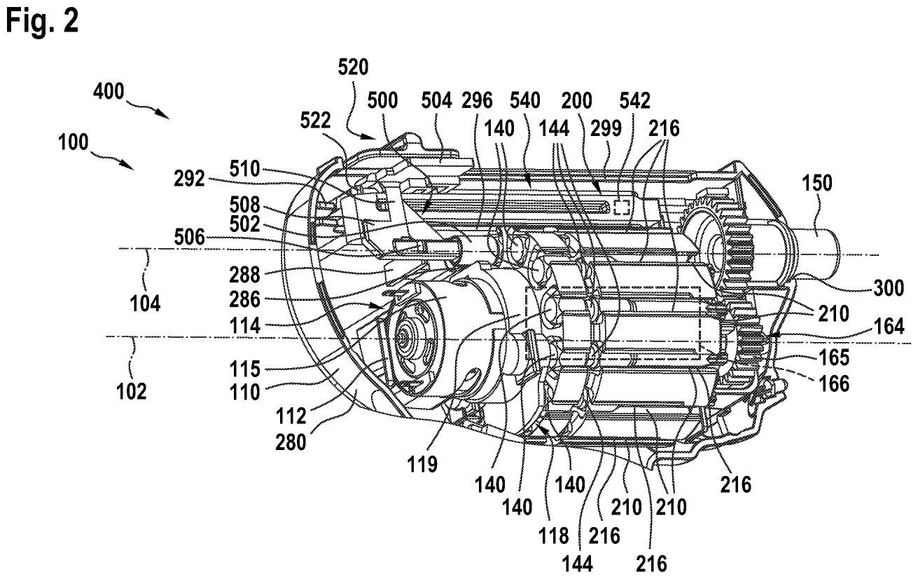

The gear unit 118 is connected to the drive motor 114 via a motor shaft 116. The gear unit 118 is provided to convert a rotation of the motor shaft 116 into a rotation between the gear unit 118 and the tool holder 150, wherein the gear unit 118 and the tool holder 150 are connected to each other via an intermediate gear 164. The gear unit 118 has a gear housing 119, which is arranged at least partially in the housing 110, see also FIG. 2. The hand-held power tool 100 comprises a tool axis 102, wherein a rotational axis of the drive shaft 116 forms the tool axis 102. In addition, the hand-held machine tool comprises a further tool axis 104, which is formed by a rotation axis of the tool axis 150. The term “axial” is to be understood as essentially parallel to the tool axis 102 and/or to the further tool axis 104. The term “radial” is to be understood as essentially perpendicular to the tool axis 102 and/or to the further tool axis 104.

Furthermore, the gear unit 118 comprises a gear output shaft 136. The gear output shaft 136 drives the tool holder 150 via the intermediate gear 164. The gear output shaft 136 protrudes at least in sections from an insert tool magazine 200. Furthermore, the motor shaft 116 and the gear output shaft 136 are arranged coaxially to one another. The intermediate gear 164 comprises at least one gearwheel 165, which is connected to the gear output shaft 136, see also FIG. 2.

The tool holder 150 is molded and/or formed on the output shaft 124. The tool holder 150 is preferably arranged in an axial direction 132 facing away from the drive unit 111. The tool holder 150 is designed here as a hexagon socket, in the form of a bit holder, which is provided to hold an insert tool 140. The insert tool is designed in the form of a screwdriver bit having a polygonal external coupling 142. The insert tool 140 can have an axial length of up to 50 mm.

The hand-held power tool 100 comprises a control unit 170 at least for controlling the drive unit 111, in particular the drive motor 114. The housing 110 at least partially holds the control unit 170. The control unit 170 comprises a microprocessor not shown in detail.

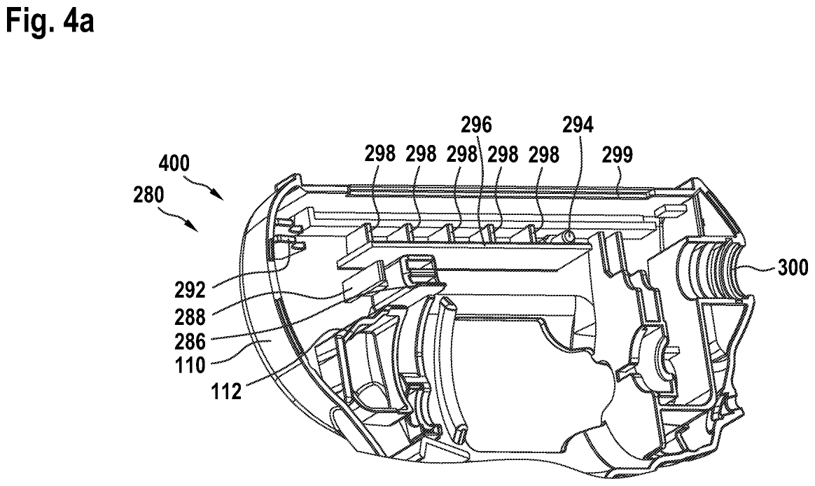

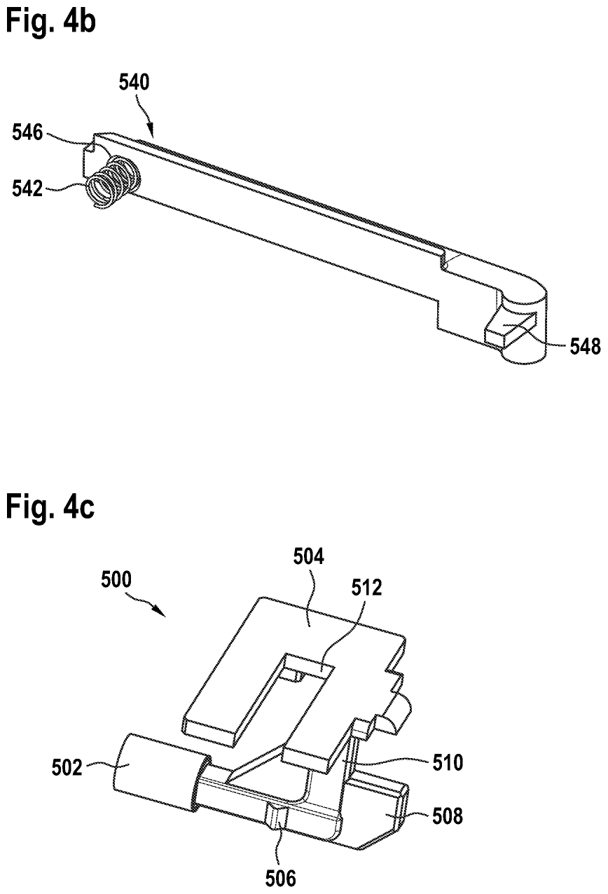

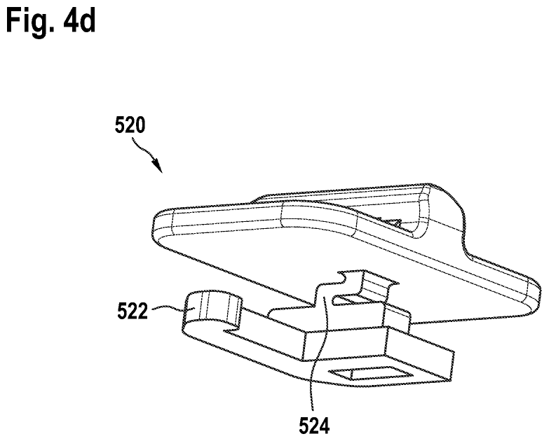

The hand tool machine 100 comprises the insert tool magazine 200 for storing a plurality of selectable insert tools 140, see also FIG. 2. The gear unit 118 is arranged at least in sections within the insert tool magazine 200, see also FIG. 2. The housing 110 at least partially holds the tool holder 150, the drive motor 114, the gear unit 118 and the insert tool magazine 200. In this example, the housing 110 is shaped as a shell housing with two half shells, see also FIGS. 2 and 4. The housing 110 comprises two housing halves 280. The housing 110 comprises at least one motor holder 112 formed on each of the two half-shells. The motor holder 112 is designed to at least partially hold the motor housing 115 and to be arranged essentially within the housing 110.

The insert tools 140 can each have a circumferential groove 144, see also FIG. 2. The insert tool magazine 200 is shaped as a drum magazine comprising a plurality of insert tool chambers 210, see also FIG. 2. The insert tool magazine 200 is rotatably formed relative to the housing 110, wherein the insert tool magazine 200 is arranged at least partially within the housing 110. The insert tool chambers 210 are shaped such that in each case one of the insert tools 140 can be received in one of the insert tool chambers 210, wherein the insert tool chambers 210 are each shaped in the manner of a hollow cylinder. In each case, one of the insert tool chambers 210 at least partially encloses the respective insert tool 140 at least in the circumferential direction of the respective insert tool 140, see also FIG. 2.

FIG. 2 shows a section 400 of a perspective longitudinal section of the hand-held machine tool 100 in a parking position. The housing 110 comprises a tool holder opening 300, in which the tool holder 150 is rotatably arranged. The tool holder opening 300 is circular in shape, for example. Furthermore, the tool holder 150 protrudes at least partially out of the tool holder opening 300 from the housing 110. In each case, one of the housing halves 280 has at least one half of the tool holder opening 300, so that both housing halves 280 then form the tool holder opening 300. The tool holder opening 310 is designed such that the tool holder 150 is rotatably arranged in the housing 110 via the tool holder opening 300.

The gear housing 119 is arranged in a radial direction to the tool axis 102 between the planetary gear 166 and the insert tool magazine 200. The planetary gear 166 is arranged in the axial direction to the tool axis 102 between the drive motor 114 and the intermediate gear 164, in particular the gear 165 of the planetary gear 164. The planetary gear 166 is essentially arranged completely within the insert tool magazine 200. The drive motor 114, in particular the motor housing 115, is arranged at least in sections within the insert tool magazine 200. The insert tool magazine 200 overlaps the drive motor 114 at least in sections. The drive motor 114 is arranged essentially concentrically to the insert tool magazine 200, at least in sections.

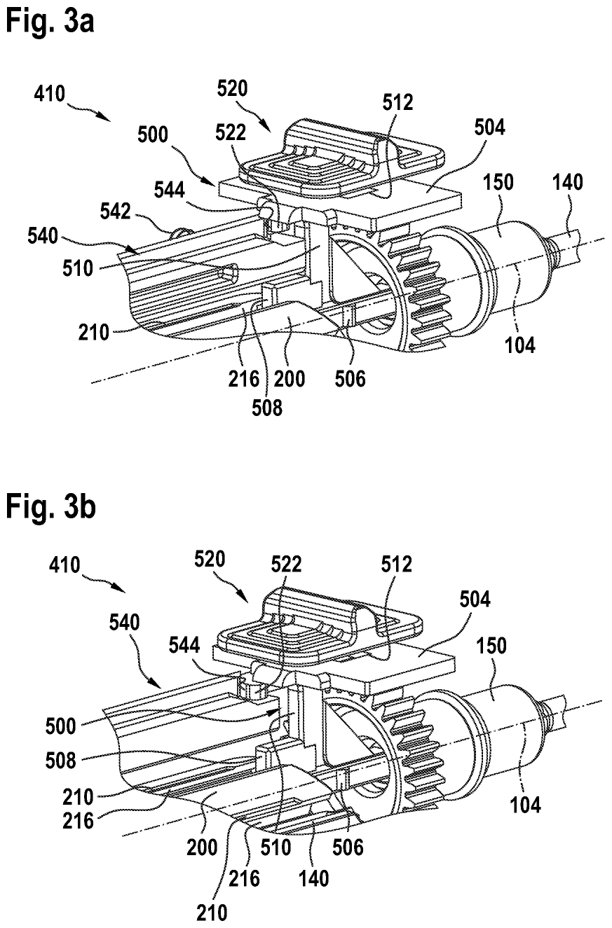

The hand-held machine tool 100 comprises a feed element 500, wherein the feed element 500 is shaped in the manner of a slide, see also FIGS. 3 and 4. The feed element 500 is designed to move one of the insert tools 140 from the park position out of one of the insert tool chambers 210 into a working position in the tool holder 150. The hand-held machine tool 100 comprises an actuating element 520, wherein the actuating element 520 is shaped as an actuating slide, see also FIGS. 3 and 4. The actuating element 520 is designed to actuate the feed element 500. The hand-held machine tool 100 comprises a support element 540, wherein the support element 540 is exemplarily shaped as a type of support lever, see also FIGS. 3 and 4. The support element 540 is designed to support the feed element 500 at least in the working position in the tool holder 150. The support element 540 is arranged at least partially between the insert tool magazine 200 and the actuating element 520, see also FIG. 2b.

The feed element 500 is arranged at least partially within the housing 110. The housing 100 at least partially encloses the feed element 500. The feed element 500 comprises a connecting element 502 for at least one of the insert tools 140. The connecting element 502 is shaped to establish a connection with at least one of the insert tools 140, wherein the connecting element 502 is shaped as a magnet, for example.

In the parked position, the insert tools 140 are each arranged in one of the insert tool chambers 210 of the insert tool magazine 200, wherein the insert tool magazine 200 can be rotated in the parked position. In the park position, the feed element 500 is arranged radially to the tool axis 102 between the actuating element 520 and the drive motor 114. When the feed element 500 is displaced in the direction of the working position, the feed element 500 is axially displaceable along the tool axis 102 and/or the further tool axis 104.

The actuating element 520 is coupled to the feed element 500 such that actuation of the actuating element 520 actuates the feed element 500, wherein the actuating element 520 can be actuated by a user from outside the housing 110. In doing so, the user actuates the actuating element 520 and at the same time indirectly also the feed element 500. In this way, the user can move the actuating element 520 from the park position to the working position and vice versa, in particular shift it. The housing 110 is arranged at least in sections and at least partially, in particular radially to the tool axis 102, between the actuating element 520 and the feed element 500, see also FIG. 2b. In the parking position, the support element 540 is arranged radially to the tool axis 102 at least partially between the drive motor 114 and the actuating element 520.

The insert tool magazine 200 is arranged at least partially, in particular radially, between the gear unit 118 and the support element 540. In addition, the insert tool magazine 200 is arranged radially to the drive motor 114 and/or the gear unit 118 essentially within the housing 110. The insert tool magazine 200 is arranged at least in sections, in particular radially, between the gear unit 118 and the support element 540. The support element 540 at least partially covers the insert tool magazine 200 and the gear unit 118.

The insert tool chambers 210 each comprise an axial groove 216, which is formed axially to the tool axis 102 and/or the further tool axis 104. The groove 216 is shaped in such a way that the feed element 500 can be guided axially through the respective groove 216 from the parking position into the working position. The grooves 216 of the respective insert tool chambers 210 are formed on the insert tool magazine 200 in the circumferential direction, wherein they have a comparable, in particular essentially the same, axial length as the insert tool magazine 200. When the feed element 500 is moved axially in the direction of the working position, the feed element 500 can be moved over the respective groove 216 and the respective insert tool chamber 210 until the feed element 500 is arranged in the parking position.

The feed element 500 comprises an alignment element 504, wherein the alignment element 504 is exemplarily shaped as a plate. The alignment element 504 is designed to align the feed element 500 relative to the housing 100 from the parking position to the working position. The alignment element 504 is at least partially in contact with the housing 110. The housing 110 is arranged at least partially and at least in sections radially to the tool axis 102 and/or to the further tool axis 104 between the feed element 500 and the actuating element 520. During the displacement of the feed element 500 from the parking position to the working position and vice versa, the alignment element 504 prevents the feed element 500 from tilting.

The housing 110 comprises a holder 286 for the connecting element 502 of the feed element 500, wherein the holder 286 is shaped like a shell. By way of example, each housing half 280 forms a holder 286 for the connecting element 502 of the feed element 500. The holder 286 for the connecting element 502 of the feed element 500 is shaped such that the holder 286 at least partially receives and at least supports the connecting element in the parking position, see also FIG. 4. Here, the housing 110 exemplarily forms the holder 286 for the connecting element 502, so that these are in one piece. The holder 286 for the connecting element 502 of the feed element 500 is arranged radially to the tool axis 102 at least partially between the drive motor 114 and the actuating element 520 and/or the feed element 500 in the parking position within the housing 110.

The feed element 500 comprises at least one locking element 506, wherein two ramp-like locking elements 506 are provided here by way of example, which are formed opposite one another on the feed element 500. The housing 110 comprises at least one locking holder 288, wherein here for example each half of the housing 280 in each case forms a web-like locking holder 288. The locking holder 288 is shaped in such a way that the locking holder 288 locks the locking element 506 in the parking position. When the feed element 500 is moved from the working position to the parking position, the locking element 506 can engage behind the locking holder 288.

The housing 110 comprises a holder 292 for a free end of the support element 540. The free end of the support element 540 is arranged essentially inside the housing 110 and opposite the tool holder 150. The free end of the support element 540 is received by the holder 292 of the housing 110 for the free end of the support element 540 such that the support element 540 is pivotably molded essentially within the housing 110.

FIG. 3a shows a section 410 of the blocked feed element 500 of the hand-held machine tool 100 in the working position. In the working position, at least one of the insert tools 140 is arranged in the tool holder 150. At least one of the insert tools 140 was axially displaced by means of the feed element 500 from one of the insert tool chambers 210 in the direction of the tool holder 150 and arranged in the tool holder 150. In the working position, the feed element 500 is arranged radially at least partially to the tool axes 102 at least partially between a gear neck of the gear unit 118, which is not shown in detail, and the actuating element 520, see also FIG. 2. Furthermore, feed element 500 is shaped in such a way that feed element 500 at least partially surrounds support element 540, see also FIG. 2. In the working position, the support element 540 is arranged radially to the tool axis 102 at least partially between the insert tool magazine 200 and the actuating element 520. The support element 540 is shaped to support the feed element 500 at least in the working position in the tool holder 140. As soon as the feed element 500 has been moved into the working position, the support element 540 swivels in such a way that the support element 540 is arranged axially behind the feed element 500. The support element 540 is designed in such a way that the support element 540 releases the feed element 500 in the parked position so that the feed element 500 can be moved. The support element 540 is arranged along the further tool axis 104. The support element 540 can be pivoted tangentially to the circumferential direction of the tool axis 102 and/or the further tool axis 104, so that the support element 540 can be pivoted tangentially to the insert tool magazine 200.

The support element 540 comprises a spring element 542, which is shaped as a spiral spring by way of example, see also FIGS. 2 and 4. The spring element 542 is arranged between the support element 540 and the housing 110, see also FIG. 2. The spring element 542 acts on the support element 540 radially in the direction of the further tool axis 104. If the feed element 500 has passed over the support element 540 when it is moved from the park position to the working position, the spring element 542 presses the support element 540 behind the feed element 500 in order to block it.

The feed element 500 comprises a blocking rib 508. The blocking rib 508 is designed to engage in the working position in at least one of the, in particular axial, grooves 216 of the insert tool chambers 210. The blocking rib 508 is formed on the feed element 500 in the direction of the drive motor 114. Here, the feed element 500 forms the blocking rib 508 so that these are in one piece. The blocking rib 508 is arranged opposite the connecting element 502 of the feed element 500 for the insert tool 140 on the feed element 500. The blocking rib 508 engages in the respective groove 216 in such a way that in the working position the insert tool magazine 200, in particular the respective insert tool chamber 210, is blocked against rotations of the insert tool magazine 200. The locking element 506 is arranged axially between the blocking rib 508 and the connecting element 502 of the feed element 500.

The actuating element 520 is coupled to the feed element 500 in such a way that the actuating element 520 is at least partially movable relative to the feed element 500. When the actuating element 520 is adjusted from the working position towards the parking position, the actuating element 520 moves at least partially transversely to the further tool axis 104 in order to adjust the support element 540. The actuating element 520 comprises a connecting element 524 for the feed element 500, wherein the connecting element 524 is shaped like a step, see also FIGS. 3b and 4. The feed element 500 comprises a holder 512 for the connecting element 524 of the actuating element 520, wherein the holder 512 for the connecting element 524 of the feed element 500 receives the connecting element 524 in such a way that the actuating element 520 can be displaced transversely to the further tool axis 104. The holder 512 for the connecting element 524 is shaped in a U-shape as an example, see also FIG. 4. The alignment element 504 and the holder 512 of the feed element 500 for the actuating element 520 are in one piece here.

The feed element 500 comprises a contact web 510. The contact web 510 is shaped in such a way that the support element 540 blocks the contact web 510 in the working position. Here, the contact web 510 is formed radially to the tool axis 102 and/or the further tool axis 104 on the feed element 500, wherein here the feed element 500 forms the contact web 510, so that these are in one piece. The contact web 510 is arranged radially, at least in sections, between the holder 512 of the feed element 500 for the actuating element 520 and the connecting element 502 of the feed element 500. The support element 540 is designed in such a way that in the working position, in particular axially, it rests behind the contact web 510. The contact web 510 is shaped in such a way that the contact web 510 can be guided through one of the grooves 216 of the insert tool chambers 210 from the parking position into the working position, see also FIGS. 2 and 3b. The contact web 510 is additionally shaped to align the insert tool magazine 200 with the respective groove 216 of the insert tool chamber 210 relative to the tool holder 150. The contact web 510 is arranged radially between the holder 512 of the feed element 500 for the actuating element 500 or the alignment element 504 and the connecting element 502 of the feed element 500. The contact web 510 is shaped in such a way that the contact web 510 acts on the support element 540 radially in the direction away from the further tool axis 104 during a movement from the park position into the working position, see also FIG. 2.

FIG. 3b shows the section 410 of the released feed element 500 of the hand-held machine tool 100. The actuating element 520 comprises an adjusting element 522, which is exemplarily shaped like a hook. The actuating element 520 forms the adjusting element 522 so that they are in one piece. The adjusting element 522 is designed to adjust the support element 540 during movement from the working position. The adjusting element 522 is shaped in such a way that when the actuating element 520 is moved from the working position to the park position, the adjusting element 522 first rests against the support element 540. When the actuating element 520 is moved further towards the parking position, the adjusting element 522 moves the support element 540 towards the housing 110. The adjusting element 522 pivots the support element 540 transversely to the tool axis 102 and/or the further tool axis 104. The support element 540 comprises a contact surface 544, which is shaped like a ramp. The contact surface 544 is shaped in such a way that the adjusting element 522 rests against the contact surface 544 when the actuating element 520 is moved from the working position into the parking position.

FIG. 4a shows a perspective view 400 of the housing half 280 of the housing 110 of the hand-held machine tool 100. The housing 110 can comprise a holder 294 for the spring element 542, wherein the holder 294 for the spring element 542 is shaped like a bolt. The holder 294 for the spring element 542 is shaped to receive the spring element 542 and to arrange it relative to the support element 540. The housing 110 forms the holder 294 for the spring element 542, so that these are in one piece. In addition, the housing 110 has a support element 296 for the support element 540, which is designed to support the support element 540 at least radially with respect to the tool axis 102. Furthermore, the support element 540 can rest on the support element 296. The support element 296 is formed as a support edge and is integral with the housing 110. In addition, the housing 110 has stop elements 298, which are designed to support the support element 540 when the support element 540 has been pivoted. The stop elements 298 are integral with the housing 110. In the parking position, the support element 540 can rest at least partially against the stop elements 298. The stop elements 298 are shaped here as stop bars. The housing 110 comprises an axial groove 299, which at least partially holds the connecting element 524 of the actuating element 520. Each housing half 280 comprises one of the axial grooves 299, so that the connecting element 524 of the actuating element 520 is at least partially enclosed by the housing 110 and the actuating element 520 is axially displaceable along the housing 110.

FIG. 4b shows a perspective view of the support element 540 of the hand-held machine tool 100. The support element 540 comprises a holder 546 for the spring element 542, which is shaped like a pot. The spring element 542 is arranged between the holder 294 of the housing 110 for the spring element 542 and the holder 546 of the support element 540 for the spring element 542, see also FIG. 2. The support element 540 comprises a guide element 548, which engages in the holder 292 for the support element 540 of the housing 110. Furthermore, the guide element 548 guides the support element 540 when the support element is pivoted.

FIG. 4c shows a perspective view of the feed element 500 of the hand-held machine tool 100. The holder 512 for the actuating element 520 at least partially encloses the connecting element 524. This allows the actuation of the actuating element 520 by the user to be transferred to the feed element 500. FIG. 4d shows a perspective view of the actuating element 520 of the hand tool 100.

What is claimed is:

1. A hand-held power tool, comprising:
a housing having an insert tool magazine which has a plurality of insert tool chambers configured to hold a respective one of a plurality of insert tools, the insert magazine arranged rotatably in the housing; and
a tool holder configured to rotatably driving at least one of the plurality of insert tools, wherein
the tool holder is arranged rotatably in a tool holder opening of the housing with a feed element which is designed to displace one of the plurality of insert tools from a park position, out of one of the plurality of insert tool chambers, and into a working position in the tool holder, with an actuating element which is designed to actuate the feed element, and with a supporting element which is designed to support the feed element at least in the working position in the tool holder, and
the support element is arranged at least partially between the insert tool magazine and the actuating element.

2. The hand-held machine tool according to claim 1, wherein the insert tool magazine is arranged at least partially, in particular radially, between a gear unit and the supporting element.

3. The hand-held machine tool according to claim 1, wherein the plurality of insert tool chambers each have at least one, in particular axial, groove through which the feed element is configured to be guided as it displaces the one of the plurality of insert tools from the park position into the working position.

4. The hand-held machine tool according to claim 3, wherein the feed element has at least one blocking rib which, in the working position, engages in at least one of the, in particular axial, grooves of the plurality of insert tool chambers.

5. The hand-held machine tool according to claim 1, wherein the actuating element has at least one adjusting element which is designed to adjust the supporting element during a movement from the working position.

6. The hand-held machine tool according to claim 1, wherein the actuating element is coupled to the feed element such that the actuating element is at least partially movable relative to the feed element.

7. The hand-held machine tool according to claim 1, wherein the feed element has at least one contact web which is designed such that the support element blocks the contact web in the working position.

8. The hand-held machine tool according to claim 7, wherein the contact web is designed such that the contact web is guided through one of the grooves of the plurality of insert tool chambers from the parking position into the working position.

9. The hand-held machine tool according to claim 7, wherein the contact web is designed such that the contact web acts on the support element during a movement from the park position into the working position.

10. The hand-held machine tool according to claim 1, wherein the feed element has at least one alignment element which is designed to align the feed element relative to the housing from the parking position to the working position.

11. The hand-held power tool according to claim 1, wherein the hand-held power tool is a screwdriver.
